(19) United States
(12) Patent Application Publication
(10) Pub. No.: US 2025/0260197 A1
(43) Pub. Date: Aug. 14, 2025

(54) CONNECTOR UNIT AND WIRE HARNESS

(71) Applicant: YAZAKI CORPORATION, Tokyo (JP)

(72) Inventors: Atsunori Iwashita, Makinohara-shi (JP); Masahiro Nakagawa, Makinohara-shi (JP); Takahiro Kubo, Makinohara-shi (JP); Hiroshi Shinba, Fujieda-shi (JP); Ayumu Ishikawa, Fujieda-shi (JP)

(21) Appl. No.: 19/002,732

(22) Filed: Dec. 27, 2024

(30) Foreign Application Priority Data
Feb. 8, 2024 (JP) 2024-017567

(51) Int. Cl. H01R 13/621; H01R 13/506; H01R 13/52

(52) U.S. Cl. CPC H01R 13/6215; H01R 13/506; H01R 13/5202; H01R 13/5205

(57) ABSTRACT

A connector unit includes a first connector, a second connector, and a fastener member. The fastener member includes a bolt, a collar supported in such a manner as to be slidable along a fastening direction between a fastened position where the collar has contact with first connection terminal, and a fastening released position where the collar is separated from the first connection terminal, a nut to which a shaft portion of the bolt is fastened in a state in which the nut sandwiches the first connection terminal, the second connection terminal, and the collar between the nut and a head portion of the bolt, and an engagement member that is provided on the bolt and engaged with the collar, moves the collar from the fastening released position to the fastened position in accordance with a fastening operation of the bolt.

### CROSS-REFERENCE TO RELATED APPLICATION(S)

The present application claims priority to and incorporates by reference the entire contents of Japanese Patent Application No. 2024-017567 filed in Japan on Feb. 8, 2024.

### BACKGROUND OF THE INVENTION

### 1. Field of the Invention

The present invention relates to a connector unit and a wire harness.

### 2. Description of the Related Art

As a conventional technique related to a connector unit of a wire harness, for example, Japanese Patent Application Laid-open No. 2014-96310 A discloses a connector unit including a first connector having a first connection terminal, a second connector having a second connection terminal, and a fastener member fastening the first connection terminal and the second connection terminal.

Meanwhile, the above-described connector unit described in Japanese Patent Application Laid-open No. 2014-96310 A, for example, has room for improvement in appropriately performing a fastening work of the first connection terminal and the second connection terminal by the fastener member.

### SUMMARY OF THE INVENTION

The present invention has been devised in view of the above-described circumstances, and the object of the present invention is to provide a connector unit and a wire harness that can appropriately perform a fastening work of terminals.

In order to achieve the above mentioned object, a connector unit according to one aspect of the present invention includes a first connector including a first connection terminal; a second connector that includes a second connection terminal to be electrically connected with the first connection terminal, and is fitted with the first connector along an axis line direction; and a fastener member configured to fasten the first connection terminal and the second connection terminal, wherein the fastener member includes: a bolt extending along a fastening direction intersecting with the axis line direction; a collar having electrical conductivity that is supported in such a manner as to be slidable along the fastening direction between a fastened position where the collar has contact with one of the first connection terminal and the second connection terminal arranged along the fastening direction, and a fastening released position where the collar is separated from the one; a nut that has contact with another one of the first connection terminal and the second connection terminal, to which a shaft portion of the bolt is fastened in a state in which the nut sandwiches the first connection terminal, the second connection terminal, and the collar between the nut and a head portion of the bolt; and an engagement member that is provided on the bolt and engaged with the collar, moves the collar from the fastening released position to the fastened position together with the bolt in accordance with a fastening operation of the bolt, and moves the collar from the fastened position to the fastening released position together with the bolt in accordance with a fastening release operation of the bolt.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exemplary perspective view of a connector unit to be applied to a wire harness according to an embodiment;

FIG. 2 is an exemplary exploded perspective view of a connector unit to be applied to a wire harness according to an embodiment;

FIG. 3 is an exemplary exploded perspective view of a first connector of a connector unit according to an embodiment;

FIG. 4 is an exemplary cross-sectional view orthogonal to a width direction of a first connector according to an embodiment;

FIG. 5 is an exemplary cross-sectional view orthogonal to a fastening direction of a first connector according to an embodiment;

FIG. 6 is an exemplary perspective view of a second connector of a connector unit according to an embodiment;

FIG. 7 is an exemplary perspective view (partial cross-sectional view) illustrating a vicinity of an engagement piece of a connector unit according to an embodiment;

FIG. 8 is an exemplary perspective view of a first connector according to an embodiment, and is a diagram illustrating a state in which a slide cover is in an open position;

FIG. 9 is an exemplary cross-sectional view illustrating a vicinity of a pullback protrusion of a connector unit according to an embodiment;

FIG. 10 is an exemplary exploded perspective view of a second connector and a fastener member according to an embodiment;

FIG. 11 is an exemplary cross-sectional view of a connector unit according to an embodiment, and is a diagram illustrating a state before fastening of a fastener member;

FIG. 12 is an exemplary cross-sectional view of a connector unit according to an embodiment, and is a diagram illustrating a state after fastening of a fastener member;

FIG. 13 is an exemplary perspective view of a bolt and an engagement member of a fastener member according to an embodiment;

FIG. 14 is an exemplary perspective view of a collar of fastener member according to an embodiment;

FIG. 15 is an exemplary cross-sectional view of a fastener member according to an embodiment, and is a diagram illustrating a state in which a collar is in a fastened position; and

FIG. 16 is an exemplary cross-sectional view of a fastener member according to an embodiment, and is a diagram illustrating a state in which a collar is in a fastening released position.

### DETAILED DESCRIPTION OF THE PREFERRED EMBODIMENTS

An embodiment according to the present invention will be described in detail below based on the drawings. In addition, the present invention is not limited by the following embodiment. Further, components in the following embodiment include the ones that can be replaced by those skilled in the art, and are easy, or the ones that are substantially identical. In addition, in this specification, ordinal numbers are used only to distinguish parts, members, regions, positions, directions, and the like, and do not indicate order or priority.

### Embodiment

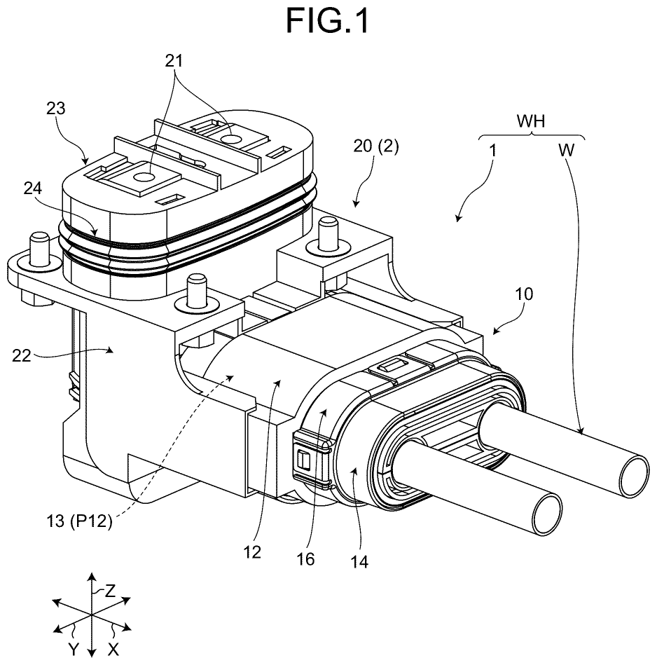

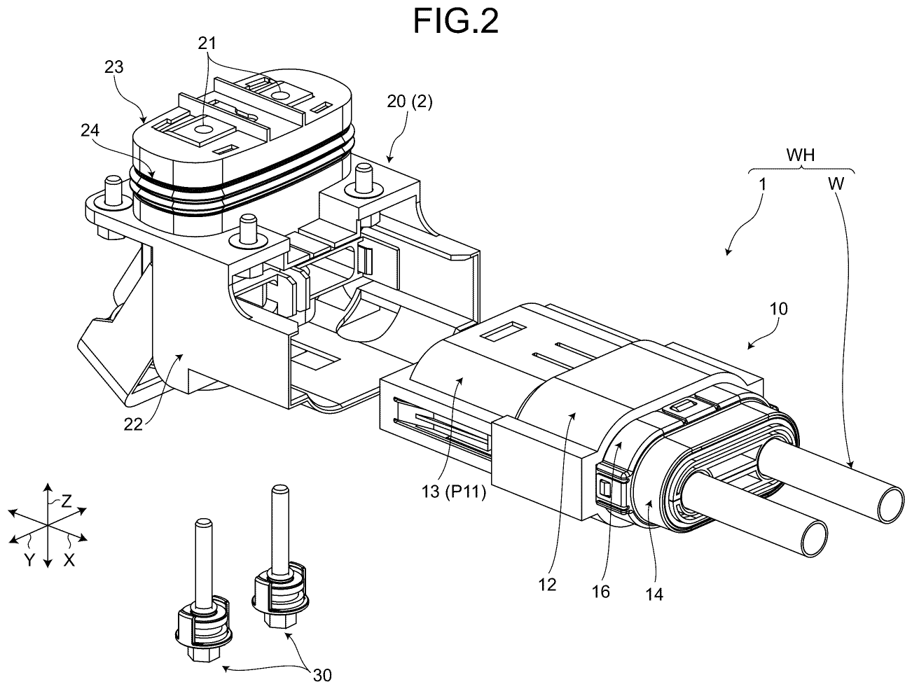

FIG. 1 is a perspective view of a connector unit 1 to be applied to a wire harness WH according to an embodiment, and FIG. 2 is an exploded perspective view of the connector unit 1. The connector unit 1 of the present embodiment illustrated in FIGS. 1 and 2 is incorporated into the wire harness WH laid in a vehicle such as an automobile. Here, the wire harness WH bundles, as a set of components, wiring materials W to be used for power supply and signal communication, for connection between devices mounted on the vehicle, for example, and connects the wiring materials W to the devices via connectors or the like. The wire harness WH of the present embodiment includes a plurality of wiring materials W having electrical conductivity, and the connector unit 1 provided at the end of the plurality of wiring materials W. The connector unit 1 includes, for example, a first connector 10 provided on the wiring material W side, a second connector 20 provided on a terminal board 2 side, and a fastener member 30 (refer to FIG. 2) that fastens a first connection terminal 11 of the first connector 10 and a second connection terminal 21 of the second connector 20, which will be described later. In addition, aside from this, the wire harness WH may further include various component parts such as a grommet and a fixing tool.

Note that, in the following description, among a first direction, a second direction, and a third direction that intersect with each other, the first direction will be referred to as an “axis line direction X”, the second direction will be referred to as a “width direction Y”, and the third direction will be referred to as a “fastening direction Z”. Here, the axis line direction X, the width direction Y, and the fastening direction Z are approximately orthogonal to each other. Typically, the axis line direction X extends along an extending direction of the plurality of wiring materials W, a fitting direction (insertion direction) of the first connector 10 and the second connector 20 of the connector unit 1, and the like. Typically, the width direction Y extends along a width direction of the connector unit 1, and the like. Typically, the fastening direction Z extends along a height direction (up-down direction) of the connector unit 1, a fastening direction of the fastener member 30 of the connector unit 1, and the like. Further, each direction to be used in the following description will be described as a direction set in a state in which the connector unit 1 is assembled to a vehicle, unless otherwise stated.

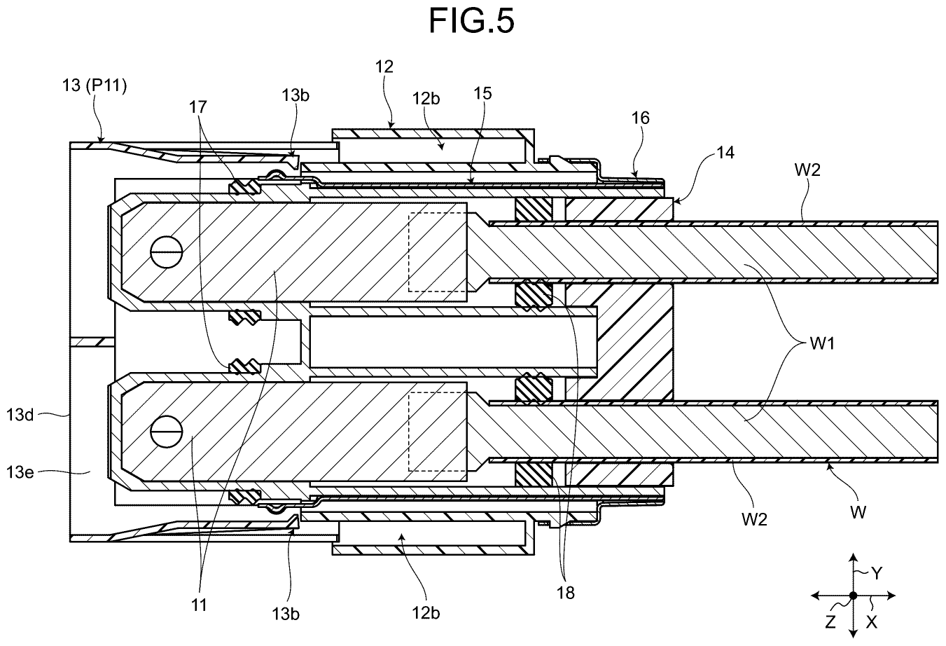

The wiring materials W each include, for example, a linear conductor portion W1 (refer to FIG. 5) having electrical conductivity, and an insulating coating W2 having an insulating property that covers the external side of the conductor portion W1. The wiring material W is an electrical insulated wire in which the conductor portion W1 is covered with the insulating coating W2. The conductor portion W1 of the present embodiment is a core wire obtained by a bundling a plurality of metal wires having electrical conductivity, but may be a twisted core wire obtained by twisting the plurality of metal wires together. The insulating coating W2 is a wire covering that covers the outer peripheral side of the conductor portion W1. The insulating coating W2 is formed by extrusion-molding an insulating resin material, or the like, for example.

The wiring materials W extend linearly along the axis line direction X, and are formed in such a manner as to extend with almost the same diameter in the axis line direction X (extending direction). Further, the wiring material W is formed in such a manner that a cross-sectional shape of the conductor portion W1 (cross-sectional shape intersecting with the axis line direction X) is an approximately round shape, and a cross-sectional shape of the insulating coating W2 is an approximately annular shape, for example, and is formed in into an approximately round shape as a whole. In at least one end of the wiring material W, the insulating coating W2 is stripped off, and the first connection terminal 11 is crimped to the conductor portion W1 exposed from the insulating coating W2.

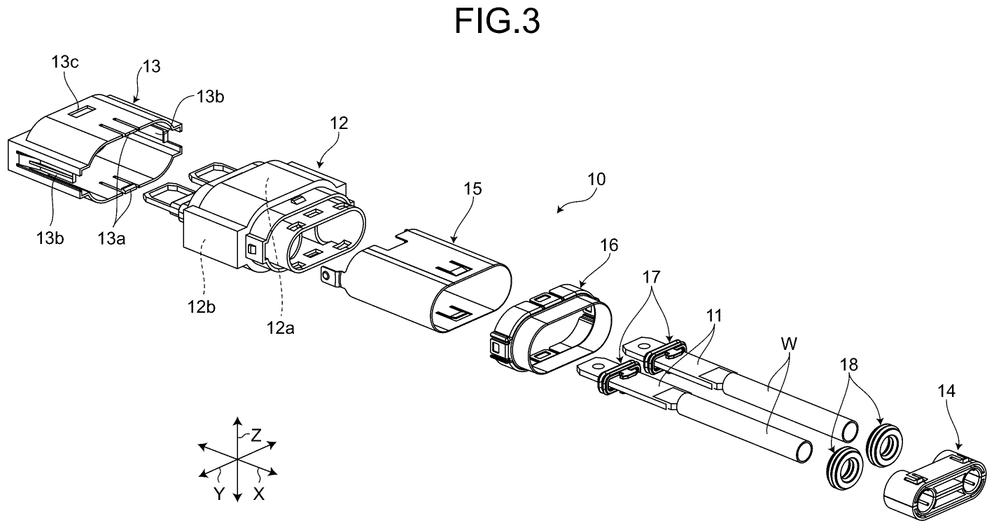

FIG. 3 is an exploded perspective view of the first connector 10 of the connector unit 1. As illustrated in FIG. 3, the first connector 10 includes, for example, the first connection terminal 11, a first housing 12, a slide cover 13, a rear holder 14, a shield shell 15, a shield ring 16, and a plurality of packings 17 and 18. In the present embodiment, a pair of first connection terminals 11, a pair of packings 17, and a pair of packings 18 are provided in such a manner as to correspond to a pair of wiring materials W.

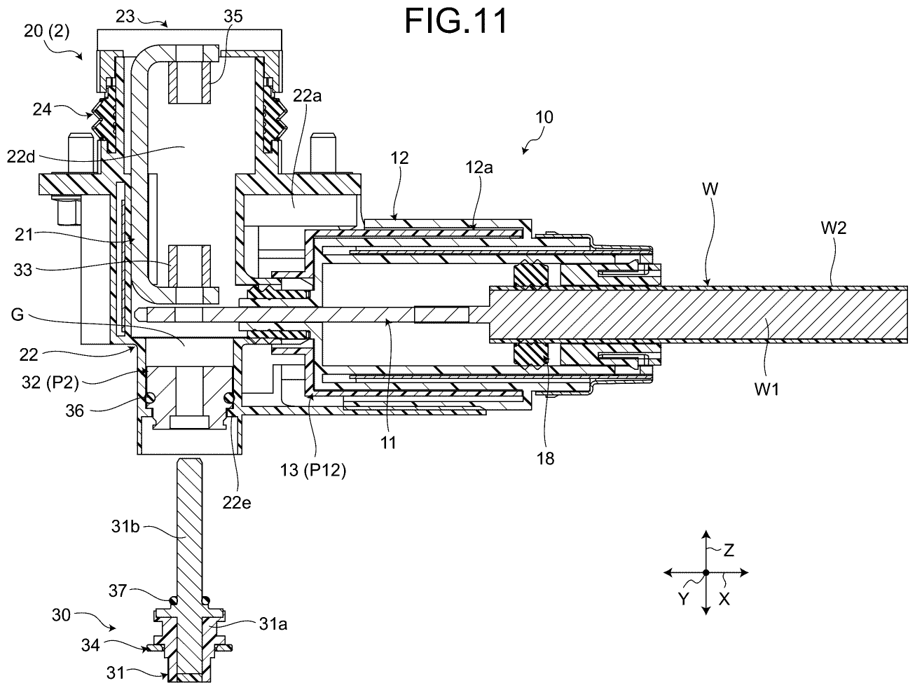

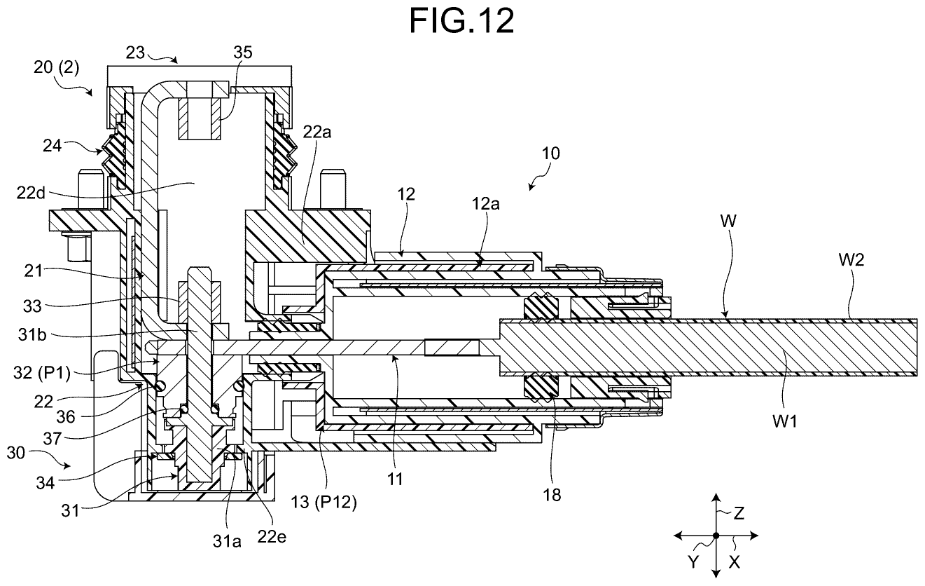

The first connection terminal 11 is a terminal fitting made of a metal material having electrical conductivity, and is electrically connected with the second connection terminal 21 of the second connector 20 (refer to FIGS. 11 and 12). The first connection terminal 11 includes, for example, an electrical connection portion to be electrically connected with the second connection terminal 21, and a wire crimping portion to be electrically connected with the end of the wiring material W. The first connection terminal 11 will also be referred to as a crimping terminal or the like.

The first housing 12 holds the first connection terminal 11 thereinside. The first housing 12 is formed into an approximately cylindrical shape in which both sides in the axis line direction X are opened, for example. In a state in which the first connection terminal 11 is attached to the inside of the first housing 12, while the first connection terminal 11 protrudes from the opening on one side in the axis line direction X, the opening on the other side in the axis line direction X is blocked by the rear holder 14. The first housing 12 is formed of a resin material having insulation.

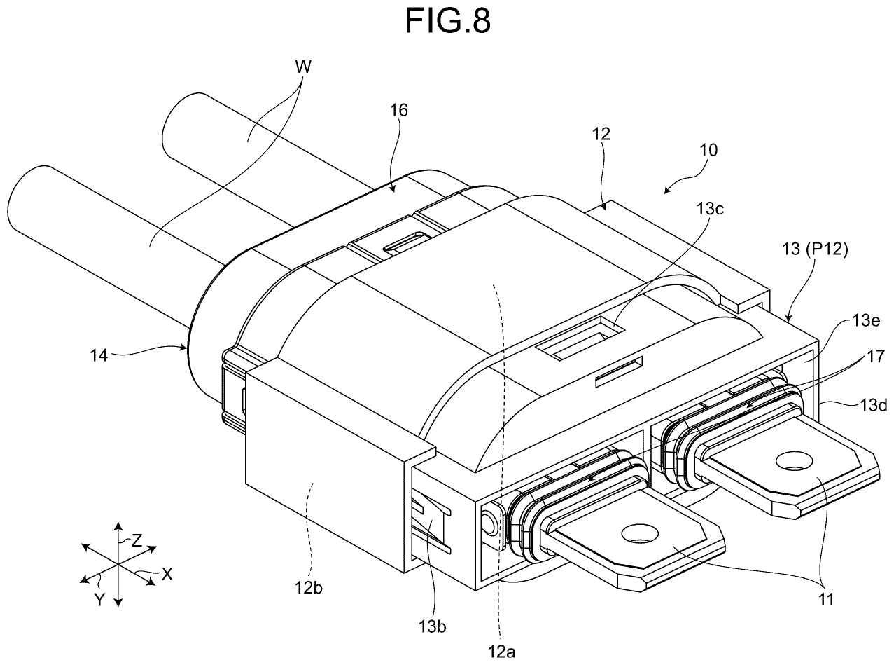

The slide cover 13 is supported in such a manner as to be slidable along the axis line direction X between a close position P11 (refer to FIG. 2) where the slide cover 13 covers the first connection terminal 11, and an open position P12 (refer to FIG. 8) where the slide cover 13 exposes the first connection terminal 11, with respect to the first housing 12. The slide cover 13 is formed into an approximately rectangular prism shape in which both sides in the axis line direction X are opened, for example. In a state of being located at the close position P11, the slide cover 13 covers the periphery of the first connection terminal 11 from both sides in the width direction Y, and covers it from both sides in the fastening direction Z. The slide cover 13 is formed of a resin material having insulation.

The rear holder 14 blocks the opening of the first housing 12 from the other side in the axis line direction X. The rear holder 14 includes a pair of dividable members that can be divided along the fastening direction Z, for example. In the pair of dividable members, a plurality of insertion holes into which the wiring materials W are to be inserted along the axis line direction X are formed. In a state in which the pair of dividable members block the openings of the first housing 12, the rear holder 14 is integrated with an inner circumferential surface of the first housing 12 by so-called snap-fit executed by claw fitting or the like. The rear holder 14 is formed of a resin material having insulation.

By covering the circumferences of the first connection terminals 11 and the wiring materials W, the shield shell 15 prevents noise generated from the first connection terminals 11 and the wiring materials W, from leaking to the outside of the first connector 10. The shield ring 16 is crimped with a braided member (not illustrated) of the wiring material W or the like, for example. The shield shell 15 and the shield ring 16 are formed into a cylindrical shape following the outer circumferential surface of the first housing 12, for example. The shield shell 15 and the shield ring 16 are formed of a metal material having electrical conductivity, for example.

The packings 17 and 18 prevent a foreign substance such as moisture from entering the first housing 12. The packings 17 and 18 are formed of elastically-deformable members such as rubber or resin. The packing 17 is formed into an approximately rectangular prism shape following the outer circumferential surface of the first connection terminal 11, for example, and fitted with the outer circumferential surface of the first connection terminal 11. The packing 18 is formed into a cylindrical shape following the outer circumferential surface of the wiring material W, for example, and fitted with the outer circumferential surface of the wiring material W. In a state in which the wiring material W is attached to the inside of the first housing 12, the packing 18 is interposed between the outer circumferential surface of the wiring material W and the inner circumferential surface of the first housing 12 (refer to FIG. 5).

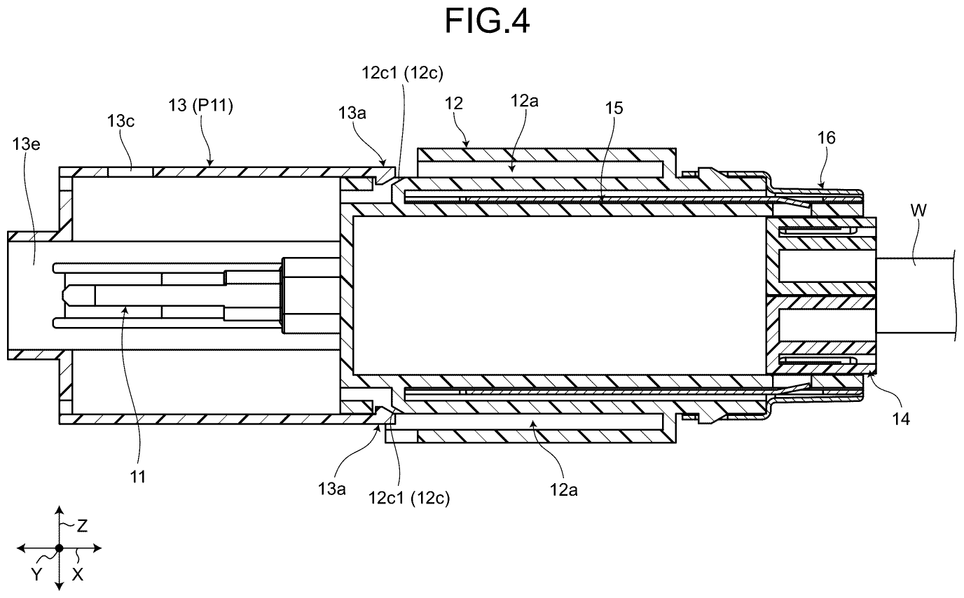

FIG. 4 is a cross-sectional view orthogonal to the width direction Y of the first connector 10. As illustrated in FIG. 4, a pair of first pocket portions 12a are provided at both ends in the fastening direction Z of the first housing 12. In a case where the slide cover 13 slides and moves from the close position P11 to the open position P12 (refer to FIG. 8), the pair of first pocket portions 12a accommodate the top wall and the bottom wall of the slide cover 13. The pair of first pocket portions 12a are provided with opening portions opened toward one side in the axis line direction X (i.e., the side of the slide cover 13 located at the close position P11).

Further, on the top wall and the bottom wall of the slide cover 13, a pair of engagement claw portions 13a to be engaged with engagement hole portions 12c of the first housing 12 are provided. The pair of engagement claw portions 13a are formed into a claw shape at another end portion in the axis line direction X on the top wall and the bottom wall of the slide cover 13. The pair of engagement hole portions 12c are formed at positions closer to one side in the axis line direction X than the pair of first pocket portions 12a on the top wall and the bottom wall of the first housing 12. The pair of engagement claw portions 13a each have an engagement surface that faces one end surface in the axis line direction X of the engagement hole portion 12c, and by the engagement surface and the one end surface being engaged in the axis line direction X, the slide cover 13 is locked at the close position P11 with respect to the first housing 12.

Further, another end surface in the axis line direction X of each of the pair of engagement hole portions 12c is provided with an inclined surface 12c1. The inclined surfaces 12c1 are inclined in such a manner as to head for both end sides in the fastening direction Z of the first housing 12 as getting closer to the other side in the axis line direction X (the pair of first pocket portions 12a side). In a case where engagement between a pair of engagement pieces 13b (refer to FIG. 5) of the slide cover 13, which will be described later, and the first housing 12, the inclined surfaces 12c1 allow the slide cover 13 to move from the close position P11 toward the open position P12 side (the pair of first pocket portions 12a side).

FIG. 5 is a cross-sectional view orthogonal to the fastening direction Z of the first connector 10. As illustrated in FIG. 5, a pair of second pocket portions 12b are provided at both ends in the width direction Y of the first housing 12. In a case where the slide cover 13 slides and moves from the close position P11 to the open position P12 (refer to FIG. 8), the pair of second pocket portions 12b accommodate a pair of side walls of the slide cover 13. Similarly to the pair of first pocket portions 12a, the pair of second pocket portions 12b are provided with opening portions opened toward one side in the axis line direction X (i.e., the side of the slide cover 13 located at the close position P11).

Further, the pair of side walls of the slide cover 13 are provided with the pair of engagement pieces 13b to be engaged with the first housing 12 along the axis line direction X. The pair of engagement pieces 13b are formed on the pair of side walls of the slide cover 13 in a cantilever spring shape. In other words, while one end portions in the axis line direction X of the pair of engagement pieces 13b are coupled with the slide cover 13, another end portions in the axis line direction X are formed as fee ends elastically-deformable along the width direction Y. The pair of engagement pieces 13b each have an engagement surface that faces the first housing 12 (i.e., one end surface in the axis line direction X of a corresponding one of the pair of second pocket portions 12b), and by the engagement surface and the one end surface being engaged in the axis line direction X, the movement of the slide cover 13 from the close position P11 toward the open position P12 side (the pair of second pocket portions 12b side) is restricted.

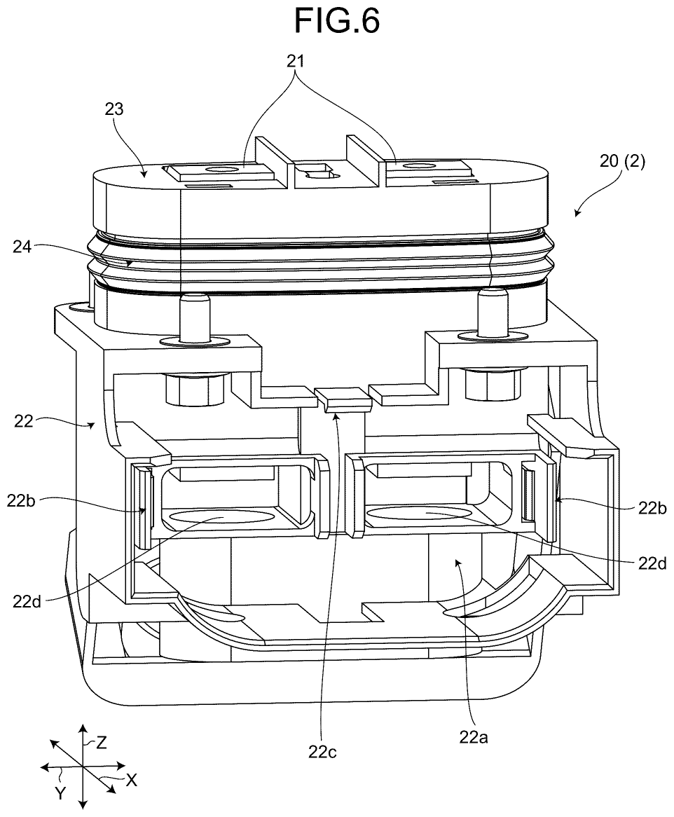

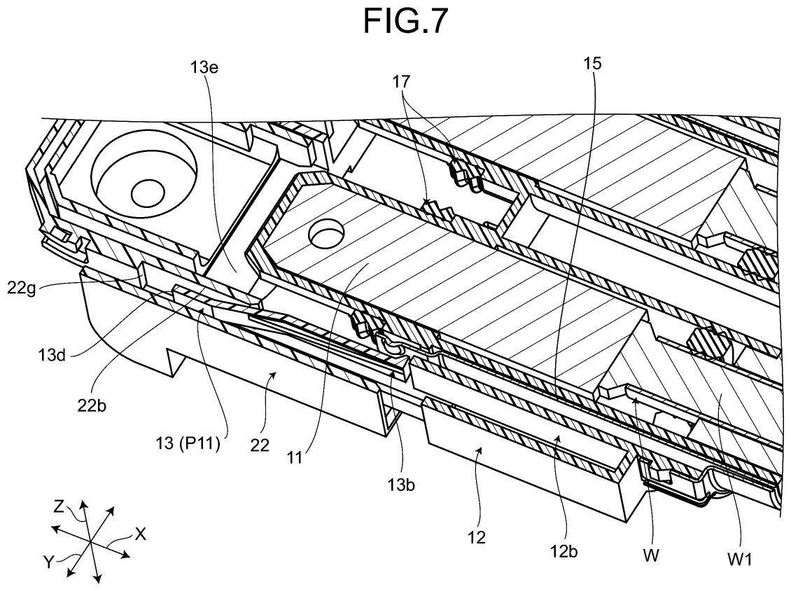

FIG. 6 is a perspective view of the second connector 20 of the connector unit 1, and FIG. 7 is a perspective view (partial cross-sectional view) illustrating the vicinity of the engagement piece 13b of the connector unit 1. As illustrated in FIGS. 6 and 7, the second connector 20 is provided with a fitting opening portion 22a into which the above-described slide cover 13 of the first connector 10 fits. The fitting opening portion 22a is formed as a recess portion with a size and a shape into which the slide cover 13 can fit, in accordance with the external shape of the slide cover 13, and in this example, is formed to have an approximately rectangular cross-sectional shape orthogonal to the axis line direction X. In the bottom portion of the fitting opening portion 22a, an opening that the above-described first connection terminal 11 enters, and is communicated with an opening portion 22d into which the fastener member 30 to be described later is to be inserted is provided.

Further, a pair of protruding portions 22b that release the engagement between the above-described pair of engagement pieces 13b and the first housing 12 is provided at both ends in the width direction Y of the fitting opening portion 22a. The pair of protruding portions 22b protrude from the bottom portion of the fitting opening portion 22a toward the other side in the axis line direction X (the slide cover 13 side). The pair of protruding portions 22b are inserted into opening portions 13e of the slide cover 13 from leading end portions 13d (refer to FIG. 7) on one side in the axis line direction X of the slide cover 13. Then, the pair of protruding portions 22b come into contact with the pair of engagement pieces 13b in accordance with a fitting operation of the first connector 10 and the second connector 20, and deform the engagement pieces 13b toward both sides in the width direction Y. The engagement between the pair of engagement pieces 13b and the first housing 12 is thereby released.

Further, in the bottom portion of the fitting opening portion 22a, a contact portion 22g that comes into contact with the leading end portion 13d of the slide cover 13 is provided. The contact portion 22g is an end surface (bottom surface) that faces the leading end portion 13d of the slide cover 13 along the axis line direction X. By having contact with the leading end portion 13d of the slide cover 13 in a state in which engagement between the above-described pair of engagement pieces 13b and the first housing 12 is released in accordance with the fitting operation of the first connector 10 and the second connector 20, the contact portion 22g moves the slide cover 13 from the close position P11 to the open position P12 with respect to the first housing 12. Consequently, the pair of engagement pieces 13b are accommodated into the pair of second pocket portions 12b (refer to FIG. 8), and the above-described pair of engagement claw portions 13a are accommodated into the pair of first pocket portions 12a.

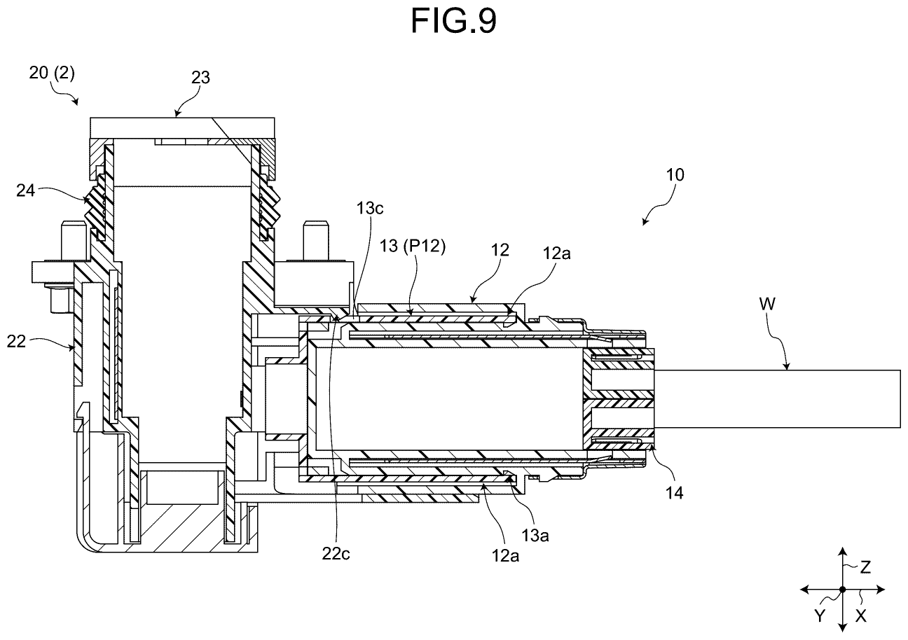

FIG. 8 is a perspective view of the first connector 10 and is a diagram illustrating a state in which the slide cover 13 is at the open position P12, and FIG. 9 is a cross-sectional view illustrating the vicinity of a pullback protrusion 22c of the connector unit 1. As illustrated in FIGS. 8 and 9, on the top wall of the slide cover 13, an engagement hole portion 13c to be engaged with the pullback protrusion 22c of the second connector 20 is provided. The pullback protrusion 22c (refer to FIGS. 6 and 9) is formed into a claw shape at the upper end of the above-described fitting opening portion 22a, and the engagement hole portion 13c is formed into an engagement hole shape penetrating through the top wall of the slide cover 13 along the fastening direction Z. Further, the engagement hole portion 13c is provided at one end portion in the axis line direction X on the top wall of the slide cover 13, and is configured to be engaged with the pullback protrusion 22c in a case where the slide cover 13 moves from the close position P11 to the open position P12.

As illustrated in FIG. 9, the pullback protrusion 22c has an engagement surface that faces one end surface in the axis line direction X of the engagement hole portion 13c. In the case of removing the first connector 10 toward the other side in the axis line direction X with respect to the second connector 20, by the engagement surface and the one end surface being engaged in the axis line direction X, the pullback protrusion 22c moves the slide cover 13 from the open position P12 to the close position P11 with respect to the first housing 12. Consequently, the pair of engagement claw portions 13a are pulled back to the outside of the pair of first pocket portions 12a, and the above-described pair of engagement pieces 13b (refer to FIG. 8) are pulled back to the outside of the pair of second pocket portions 12b.

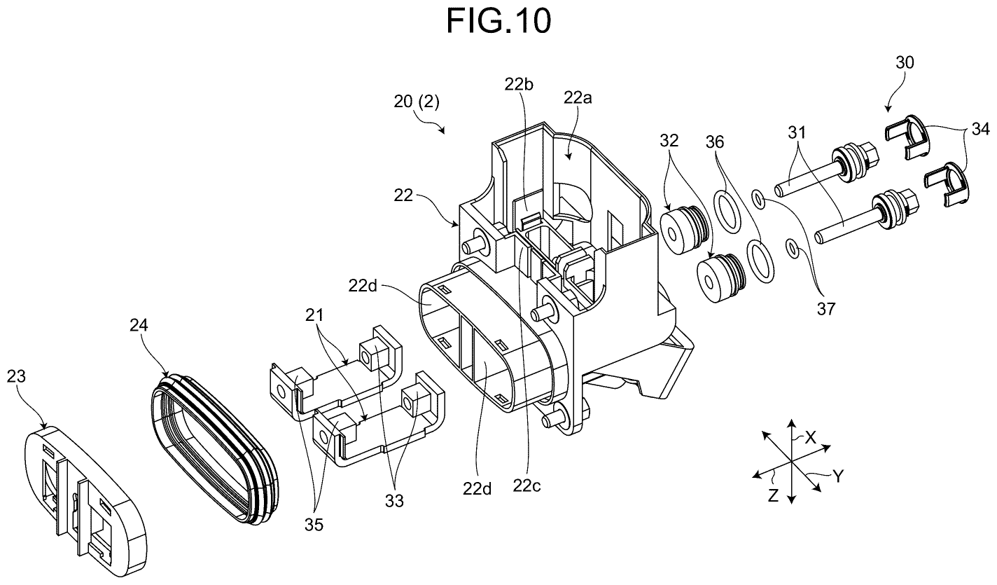

FIG. 10 is an exploded perspective view of the second connector 20 and the fastener member 30. As illustrated in FIG. 10, the second connector 20 includes, for example, the second connection terminal 21, a second housing 22, a front holder 23, and a unit packing 24. Further, the fastener member 30 includes, for example, a bolt 31, a collar 32, nuts 33 and 35, an engagement member 34, and seal members 36 and 37. In the present embodiment, a pair of second connection terminals 21, and a pair of fastener members 30 are provided in such a manner as to respectively correspond to the pair of first connection terminals 11 of the first connector 10.

The second connection terminal 21 is a terminal fitting made of a metal material having electrical conductivity, and is electrically connected with the first connection terminal 11 of the first connector 10 (refer to FIGS. 11 and 12). The second connection terminal 21 includes, for example, a first electrical connection portion to be electrically connected with the first connection terminal 11, a second electrical connection portion to be electrically connected with an external terminal, and a coupling portion that couples the first electrical connection portion and the second electrical connection portion. The second connection terminal 21 has an approximately U-shaped cross-sectional shape opened toward the other side in the axis line direction X, by the first electrical connection portion, the second electrical connection portion, and the coupling portion.

The second housing 22 holds the second connection terminal 21 thereinside. The second housing 22 is provided with the opening portion 22d into which the second connection terminal 21, the fastener member 30, and the like are inserted along the fastening direction Z. In the present embodiment, the second housing 22 is provided with a pair of opening portions 22d arranged in the width direction Y. In a state in which the second connection terminals 21 are attached to the inside of the pair of opening portions 22d, while the fastener member 30 is inserted into the pair of opening portions 22d from opening ends on the other side in the fastening direction Z, opening ends on one side in the fastening direction Z are blocked by the front holder 23. The second housing 22 is formed of a resin material having insulation.

The front holder 23 blocks the pair of opening portions 22d of the second housing 22 from one side in the fastening direction Z. Further, the front holder 23 is a member for holding the unit packing 24 between itself and the second housing 22, for example. The front holder 23 is formed into a cylindrical shape following an outer circumferential surface of a cylindrical portion of the second housing 22, and is fitted with the outer circumferential surface of the cylindrical portion. The front holder 23 is integrated with the second housing 22 by claw fitting or the like in a state of sandwiching the unit packing 24 between itself and the second housing 22.

The unit packing 24 prevents a foreign substance such as moisture from entering the second housing 22. The unit packing 24 is formed of an elastically-deformable member such as rubber or resin. The unit packing 24 is formed into, for example, an approximately ellipsoidal cylindrical shape following the outer circumferential surface of the cylindrical portion of the second housing 22, and is fitted with the outer circumferential surface of the cylindrical portion. In a state in which the terminal board 2 is connected with an external device, the unit packing 24 is interposed between the second housing 22 and the external device, for example.

FIG. 11 is a cross-sectional view of the connector unit 1 and is a diagram illustrating a state before fastening of the fastener member 30, and FIG. 12 is a cross-sectional view of the connector unit 1 and is a diagram illustrating a state after fastening of the fastener member 30. As illustrated in FIGS. 11 and 12, in the present embodiment, in a state in which the first connector 10 are the second connector 20 fitted, the first connection terminal 11 and the second connection terminal 21 are arranged along the fastening direction Z. The first connection terminal 11 and the second connection terminal 21 are provided with attachment holes into which the bolt 31 of the fastener member 30 are inserted along the fastening direction Z. Further, in the attachment hole of the second connection terminal 21, a screw hole of the nut 33 is provided on one side in the fastening direction Z with being communicated therewith, and in the attachment hole of the first connection terminal 11, a central hole of the collar 32 is provided on the other side in the fastening direction Z with being communicated therewith. Then, the first connection terminal 11, the second connection terminal 21, and the collar 32 are fastened in such a manner as to be sandwiched between a head portion 31a of the bolt 31 and the nut 33.

Here, in the present embodiment, the collar 32 is supported in such a manner as to be slidable along the fastening direction Z between a fastened position P1 (refer to FIG. 12) where the collar 32 has contact with the first connection terminal 11, and a fastening released position P2 (refer to FIG. 11) where the collar 32 is separated from the first connection terminal 11. In other words, in a state in which the collar 32 is located at the fastening released position P2, a clearance gap G extending along the fastening direction Z is formed between the collar 32 and the first connection terminal 11, and in a state in which the collar 32 is located at the fastened position P1, the clearance gap G is not formed between the collar 32 and the first connection terminal 11. In this manner, in the present embodiment, by supporting the collar 32 in such a manner as to be slidable along the fastening direction Z with respect to the opening portion 22d of the second housing 22, while electrically connecting the collar 32 and the first connection terminal 11 at the fastened position P1, electrical connection between the collar 32 and the first connection terminal 11 is prevented at the fastening released position P2.

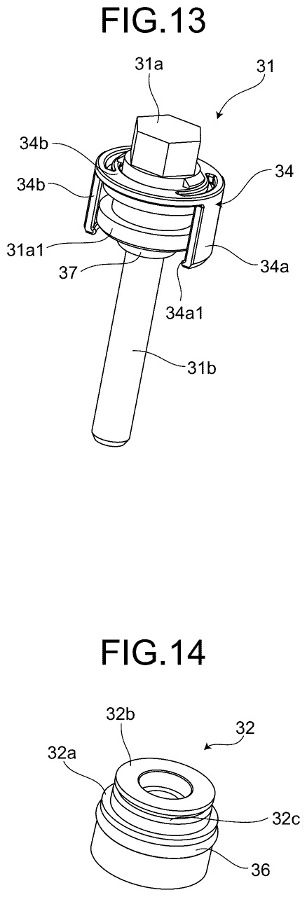

Further, in the present embodiment, on the inner surface of the opening portion 22d, a flange wall 22e supporting the collar 32 at the fastening released position P2 is provided. The flange wall 22e protrudes from the inner surface of the opening portion 22d toward the radial direction internal side of the opening portion 22d. The collar 32 has an engagement surface that faces the flange wall 22e along the fastening direction Z, and by the contact between the engagement surface and the flange wall 22e, the movement (removal) of the collar 32 toward the other side in the fastening direction Z with respect to the opening portion 22d is prevented. In addition, in the present embodiment, the flange wall 22e is provided with an opening portion that allows a pair of engagement pieces 34a (refer to FIG. 13) of the engagement member 34, which will be described later, to enter. In other words, the flange wall 22e is intermittently provided along a circumferential direction of the inner surface of the opening portion 22d.

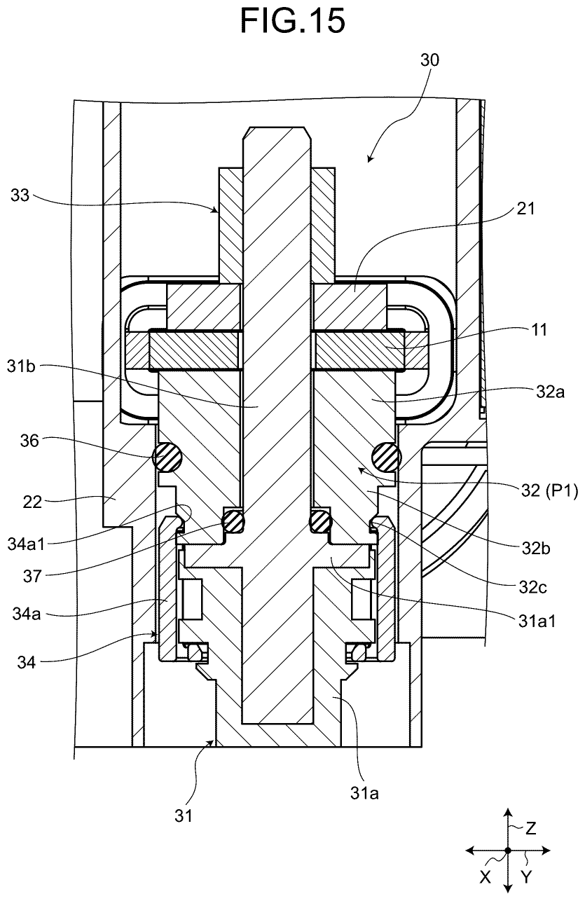

FIG. 13 is a perspective view of the bolt 31 and the engagement member 34 of the fastener member 30. As illustrated in FIG. 13, the bolt 31 includes, for example, the head portion 31a and a shaft portion 31b, and is obtained by insert molding resin at the head portion 31a of the bolt 31. At one end portion in the fastening direction Z of the head portion 31a, a flange 31a1 protruding toward a radial direction outer side of the shaft portion 31b, and having contact with the collar 32 (refer to FIG. 15) is provided. On the outer circumferential surface of the shaft portion 31b, a male screw portion to be screwed into the screw hole of the above-described nut 33 is provided. Further, a ring-shaped seal member 37 is fitted with another end portion in the fastening direction Z of the shaft portion 31b. The seal member 37 is formed of an elastically-deformable member such as rubber or resin, and stops water between itself and the central hole of the collar 32.

The engagement member 34 includes, for example, the pair of engagement pieces 34a, and a coupling portion 34b coupling the pair of engagement pieces 34a. The coupling portion 34b is formed into an annular shape provided with an opening portion into which the head portion 31a of the bolt 31 is to be inserted. The pair of engagement pieces 34a are formed with protruding from both ends in the width direction Y of the coupling portion 34b along the fastening direction Z. Leading end portions 34a1 on one side in the fastening direction Z of the pair of engagement pieces 34a are formed into a claw shape, and are engaged with groove portions 32c of the collars 32. The engagement member 34 is attached to the bolt 31, and used in a state of being integrated with the bolt 31. In other words, the engagement member 34 is provided on the bolt 31.

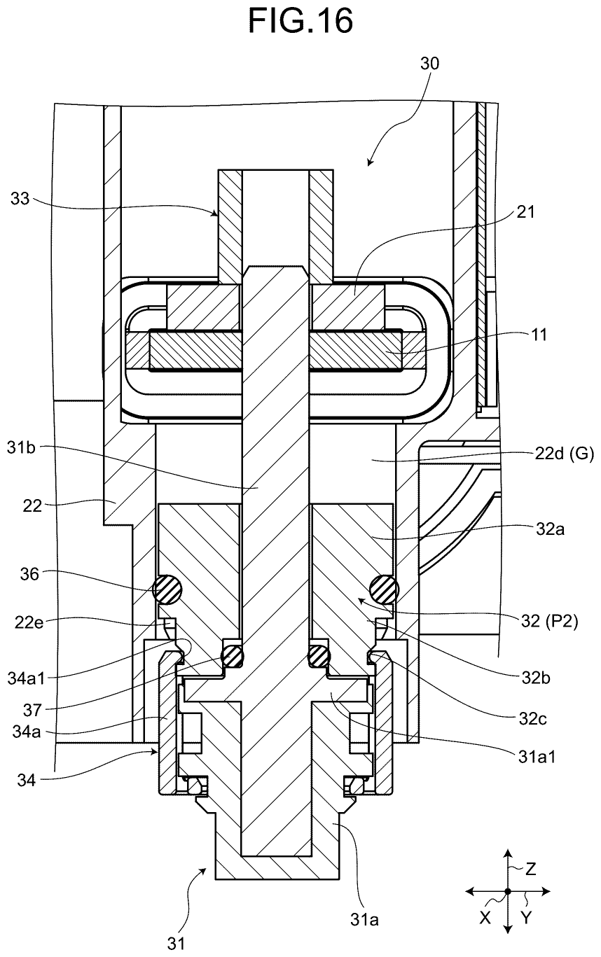

FIG. 14 is a perspective view of the collar 32 of the fastener member 30. As illustrated in FIG. 14, the collar 32 includes, for example, a large diameter portion 32a and a small diameter portion 32b formed with a diameter smaller than the large diameter portion 32a. The large diameter portion 32a is a portion located at a position closer to one side in the fastening direction Z than the flange wall 22e formed on the inner surface of the opening portion 22d, in a state in which the collar 32 is located at the above-described fastening released position P2 (refer to FIG. 16). On the outer circumferential surface of the large diameter portion 32a, a ring-shaped seal member 36 that comes into contact with the inner surface of the opening portion 22d is provided. The seal member 36 is formed of an elastically-deformable member such as rubber or resin, and stops water between itself and the inner surface of the opening portion 22d.

The small diameter portion 32b is a portion located at a position closer to the other side in the fastening direction Z than the flange wall 22e formed on the inner surface of the opening portion 22d, in a state in which the collar 32 is located at the fastening released position P2 (refer to FIG. 16). The small diameter portion 32b is provided with being exposed from an opened end of the opening portion 22d, in a state in which the collar 32 is located at the fastening released position P2. On the outer circumferential surfaces of the small diameter portions 32b, the groove portions 32c with which the leading end portions 34a1 of the pair of engagement pieces 34a of the engagement member 34 are to be engaged are provided. The groove portion 32c is formed into an annular shape following the outer circumferential surface of the small diameter portion 32b, for example. The collar 32 is formed of a metal material having electrical conductivity, for example.

FIG. 15 is a cross-sectional view of the fastener member 30 and is a diagram illustrating a state in which the collar 32 is at the fastened position P1, and FIG. 16 is a cross-sectional view of the fastener member 30 and is a diagram illustrating a state in which the collar 32 is at the fastening released position P2. As illustrated in FIGS. 15 and 16, in the present embodiment, the engagement member 34 is configured to move the collar 32 from the fastening released position P2 to the fastened position P1 together with the bolt 31 in accordance with a fastening operation of the bolt 31. For example, with respect to the collar 32 located at the fastening released position P2, the leading end portions 34a1 of the pair of engagement pieces 34a of the engagement member 34 are engaged with the groove portions 32c from the other side in the fastening direction Z in a state in which the engagement member 34 is integrated with the bolt 31. The pair of engagement pieces 34a make entry toward one side in the fastening direction Z from the opening portion formed on the flange wall 22e, when the collar 32 moves from the fastening released position P2 to the fastened position P1.

Further, in the present embodiment, the engagement member 34 is configured to move the collar 32 from the fastened position P1 to the fastening released position P2 together with the bolt 31 in accordance with a fastening release operation of the bolt 31. The pair of engagement pieces 34a move the collar 32 toward the other side in the fastening direction Z with respect to the first connection terminal 11 by the contact between the claw-shaped leading end portion 34a1 and the groove portion 32c, when moving the collar 32 from the fastened position P1 to the fastening released position P2. Accordingly, the collar 32 and the first connection terminal 11 are separated, and electrical connection of the collar 32 at the fastening released position P2 with the first connection terminal 11 can be eventually prevented.

As described above, in the connector unit 1 and the wire harness WH of the present embodiment, the fastener member 30 includes the engagement member 34 that is provided on the bolt 31 and engaged with the collar 32, moves the collar 32 from the fastening released position P2 to the fastened position P1 together with the bolt 31 in accordance with a fastening operation of the bolt 31, and moves the collar 32 from the fastened position P1 to the fastening released position P2 together with the bolt 31 in accordance with a fastening release operation of the bolt 31. With this configuration, while the connector unit 1 and the wire harness WH can bring the collar 32 and the first connection terminal 11 into contact by moving the collar 32 from the fastening released position P2 to the fastened position P1 by the engagement member 34, for example, the connector unit 1 and the wire harness WH can separate the collar 32 and the first connection terminal 11 by moving the collar 32 from the fastened position P1 to the fastening released position P2. Consequently, the connector unit 1 and the wire harness WH can appropriately perform a fastening work of the first connection terminal 11 and the second connection terminal 21, and eventually prevent electrical connection of the collar 32 at the fastening released position P2.

Further, in the connector unit 1 and the wire harness WH of the present embodiment, the second connector 20 includes the second housing 22 provided with the opening portion 22d into which the bolt 31 and the collar 32 are inserted along the fastening direction Z, and the collar 32 includes the large diameter portion 32a including the seal member 36 that is provided on the outer circumferential surface and comes into contact with the inner surface of the opening portion 22d, and the small diameter portion 32b that is formed to have a smaller diameter than the large diameter portion 32a, and includes the groove portion 32c into which the leading end portion 34a1 of the engagement piece 34a of the engagement member 34 is fitted that is provided on the outer circumferential surface. With this configuration, the connector unit 1 and the wire harness WH can slide the collar 32 between the fastened position P1 and the fastening released position P2 along the fastening direction Z by the engagement piece 34a engaged with the groove portion 32c of the small diameter portion 32b while being able to stop water to the inner surface of the opening portion 22d by the seal member 36 provided on the large diameter portion 32a of the collar 32, for example.

Further, in the connector unit 1 and the wire harness WH of the present embodiment, the first connector 10 includes the first housing 12 that holds the first connection terminal 11 in a state of protruding along the axis line direction X, and the slide cover 13 supported in such a manner as to be slidable along the axis line direction X between the close position P11 where the slide cover 13 covers the first connection terminal 11, and the open position P12 where the slide cover 13 exposes the first connection terminal 11, with respect to the first housing 12. With this configuration, the connector unit 1 and the wire harness WH can cover the periphery of the first connection terminal 11 by the slide cover 13 located at the close position P11, for example, and eventually prevent contact between the first connection terminal 11 and hands and fingers of an operator or the like.

Further, in the connector unit 1 and the wire harness WH of the present embodiment, the slide cover 13 includes the cantilever spring-shaped engagement piece 13b to be engaged with the first housing 12 along the axis line direction X at the close position P11, and the second connector 20 includes the protruding portion 22b that deforms the engagement piece 13b along the width direction Y in accordance with a fitting operation with the first connector 10, and releases engagement between the engagement piece 13b and the first housing 12. With this configuration, the connector unit 1 and the wire harness WH can release engagement between the engagement piece 13b and the first housing 12 by the protruding portion 22b, for example, in accordance with a fitting operation of the first connector 10 and the second connector 20, and eventually further prevent contact between the first connection terminal 11 and hands and fingers of an operator or the like in operations.

Further, in the connector unit 1 and the wire harness WH of the present embodiment, the second connector 20 includes the contact portion 22g that moves the slide cover 13 from the close position P11 to the open position P12 by having contact with the leading end portion 13d of the slide cover 13 in a state in which engagement between the engagement piece 13b and the first housing 12 is released in accordance with a fitting operation with the first connector 10. With this configuration, the connector unit 1 and the wire harness WH can move the slide cover 13 from the close position P11 to the open position P12 by the contact portion 22g, for example, in accordance with a fitting operation of the first connector 10 and the second connector 20, and eventually further prevent contact between the first connection terminal 11 and hands and fingers of an operator or the like in operations.

In addition, in the present embodiment, a case where the collar 32 is provided with being in contact with the first connection terminal 11, and the nut 33 is provided with being in contact with the second connection terminal 21 has been exemplified, but the configuration is not limited to this example, and for example, the collar 32 may be provided with being in contact with the second connection terminal 21 and the nut 33 may be provided with being in contact with the first connection terminal 11. Further, in the present embodiment, a case where the slide cover 13 is provided on the first connector 10 has been exemplified, but the configuration is not limited to this example, and the slide cover 13 needs not be provided on the first connector 10, for example.

Heretofore, the embodiment of the present invention has been exemplified, but the above-described embodiment is an example, and is not intended to limit the scope of the invention. The above-described embodiment can be implemented in other various configurations, and various omissions, replacements, combinations, and changes can be made without departing from the gist of the invention. Further, the above-described embodiment can be implemented with appropriately changing each configuration and the specification such as shapes (structure, type, direction, format, size, length, width, thickness, height, number, arrangement, position, material, and the like).

In the connector unit and the wire harness according to the present embodiment, the fastener member includes the engagement member that is provided on the bolt and engaged with the collar, moves the collar from the fastening released position to the fastened position together with the bolt in accordance with a fastening operation of the bolt, and moves the collar from the fastened position to the fastening released position together with the bolt in accordance with a fastening release operation of the bolt. With this configuration, while the connector unit and the wire harness can bring the collar and one of the first connection terminal and the second connection terminal into contact by moving the collar from the fastening released position to the fastened position by the engagement member, for example, the connector unit and the wire harness can separate the collar and one of the first connection terminal and the second connection terminal by moving the collar from the fastened position to the fastening released position. Consequently, the connector unit and the wire harness achieve the effect that a fastening work of terminals can be appropriately performed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector unit comprising:
a first connector including a first connection terminal;
a second connector that includes a second connection terminal to be electrically connected with the first connection terminal, and is fitted with the first connector along an axis line direction; and
a fastener member configured to fasten the first connection terminal and the second connection terminal, wherein
the fastener member includes:
a bolt extending along a fastening direction intersecting with the axis line direction;
a collar having electrical conductivity that is supported in such a manner as to be slidable along the fastening direction between a fastened position where the collar has contact with one of the first connection terminal and the second connection terminal arranged along the fastening direction, and a fastening released position where the collar is separated from the one;
a nut that has contact with another one of the first connection terminal and the second connection terminal, to which a shaft portion of the bolt is fastened in a state in which the nut sandwiches the first connection terminal, the second connection terminal, and the collar between the nut and a head portion of the bolt; and
an engagement member that is provided on the bolt and engaged with the collar, moves the collar from the fastening released position to the fastened position together with the bolt in accordance with a fastening operation of the bolt, and moves the collar from the fastened position to the fastening released position together with the bolt in accordance with a fastening release operation of the bolt.

2. The connector unit according to claim 1, wherein
the second connector includes a second housing provided with an opening portion into which the bolt and the collar are inserted along the fastening direction, and
the collar includes a large diameter portion including a seal member that is provided on an outer circumferential surface and comes into contact with an inner surface of the opening portion, and a small diameter portion that is formed to have a smaller diameter than that of the large diameter portion and includes a groove portion into which an engagement piece of the engagement member is fitted that is provided on an outer circumferential surface.

3. The connector unit according to claim 1, wherein
the first connector includes a first housing that holds the first connection terminal in a state of protruding along the axis line direction, and a slide cover supported in such a manner as to be slidable along the axis line direction between a close position where the slide cover covers the first connection terminal, and an open position where the slide cover exposes the first connection terminal, with respect to the first housing.

4. The connector unit according to claim 2, wherein
the first connector includes a first housing that holds the first connection terminal in a state of protruding along the axis line direction, and a slide cover supported in such a manner as to be slidable along the axis line direction between a close position where the slide cover covers the first connection terminal, and an open position where the slide cover exposes the first connection terminal, with respect to the first housing.

5. The connector unit according to claim 3, wherein
the slide cover includes a cantilever spring-shaped engagement piece to be engaged with the first housing along the axis line direction at the close position, and
the second connector includes a protruding portion that deforms the engagement piece along a width direction intersecting with the axis line direction and the fastening direction, in accordance with a fitting operation with the first connector, and releases engagement between the engagement piece and the first housing.

6. The connector unit according to claim 4, wherein
the slide cover includes a cantilever spring-shaped engagement piece to be engaged with the first housing along the axis line direction at the close position, and
the second connector includes a protruding portion that deforms the engagement piece along a width direction intersecting with the axis line direction and the fastening direction, in accordance with a fitting operation with the first connector, and releases engagement between the engagement piece and the first housing.

7. The connector unit according to claim 5, wherein
the second connector includes a contact portion that moves the slide cover from the close position to the open position by having contact with a leading end portion of the slide cover in a state in which engagement between the engagement piece and the first housing is released in accordance with a fitting operation with the first connector.

8. The connector unit according to claim 6, wherein
the second connector includes a contact portion that moves the slide cover from the close position to the open position by having contact with a leading end portion of the slide cover in a state in which engagement between the engagement piece and the first housing is released in accordance with a fitting operation with the first connector.

9. A wire harness comprising:
a wiring material having electrical conductivity; and
a connector unit provided at an end of the wiring material, wherein
the connector unit includes:
a first connector including a first connection terminal;
a second connector that includes a second connection terminal to be electrically connected with the first connection terminal, and is fitted with the first connector along an axis line direction; and
a fastener member configured to fasten the first connection terminal and the second connection terminal, and
the fastener member includes:
a bolt extending along a fastening direction intersecting with the axis line direction;
a collar having electrical conductivity that is supported in such a manner as to be slidable along the fastening direction between a fastened position where the collar has contact with one of the first connection terminal and the second connection terminal arranged along the fastening direction, and a fastening released position where the collar is separated from the one;
a nut that has contact with another one of the first connection terminal and the second connection terminal, to which a shaft portion of the bolt is fastened in a state in which the nut sandwiches the first connection terminal, the second connection terminal, and the collar between the nut and a head portion of the bolt; and
an engagement member that is provided on the bolt and engaged with the collar, moves the collar from the fastening released position to the fastened position together with the bolt in accordance with a fastening operation of the bolt, and moves the collar from the fastened position to the fastening released position together with the bolt in accordance with a fastening release operation of the bolt.
